(19) United States
(12) Patent Application Publication
(10) Pub. No.: US 2016/0228765 A1
(43) Pub. Date: Aug. 11, 2016

(54) COMMAND INPUT DEVICE FOR A GAME PAD, AND GAME PAD EQUIPPED WITH SUCH A DEVICE

(71) Applicant: PLAYRAPID, Saint-Remy-de-Provence (FR)

(72) Inventor: Damien RUBIO, Saint-Remy-de-Provence (FR)

(21) Appl. No.: 15/016,389

(22) Filed: Feb. 5, 2016

(30) Foreign Application Priority Data
Feb. 5, 2015 (FR) 1550906

(51) Int. Cl. A63F 13/24; A63F 9/24

(52) U.S. Cl. CPC A63F 13/24; A63F 9/24; A63F 2009/2407

(57) ABSTRACT

A command input device for a game pad is provided, the device including at least one paddle, having a fixing part, and a manipulation part, the manipulation part is positioned between the fixing part and a lateral edge of the game pad, and the paddle is curved between the fixing part and the manipulation part so that the paddle becomes further away from the rear face on the side of the manipulation part. Also provided is a game pad equipped with at least one such command device.

### BACKGROUND

The present invention relates to a command input device for a game pad. It also relates to a game pad equipped with such a command button.

The field of the invention is the field of command input devices for a games console or a computer, such as a game pad.

Most electronic or computer games are controlled by command input devices, also known as game pads.

Electronic games are becoming increasingly sophisticated and allow the input of an increasing number of commands by using command buttons. The increase in the number of commands is accompanied by an increase in command buttons on the command input devices, such as the game pads.

At the same time, actors in this field are attempting to offer command input devices that allow users to input commands more ergonomically and more quickly.

For example, the American patent published under number U.S. Pat. No. 8,641,525 B2 proposes a command input device comprising control paddles arranged on a rear face of the command device and allowing a user to enter commands by using the fingers of one hand apart from the thumb.

Each rear paddle described in said application corresponds to a flexible plastic strip. Each paddle comprises one end fixed to the game pad on the side of the upper face, extends towards the lower face, and comprises a free end on said lower face side, i.e. closer to the little finger than the index finger. As a result, depending on the finger used (apart from the thumb), it is more difficult or less difficult, or even impossible, to input commands with these paddles.

In addition, each paddle has a generally flat shape and is arranged parallel to the rear face of the game pad. Thus, a user wishing to input a command must apply pressure on the paddle in a vertical direction with respect to the game pad, in particular the rear face of the game pad. However, it is not ergonomic to apply pressure perpendicular to the rear face of the game pad using a finger of a hand that is holding the game pad.

A purpose of the present invention is to overcome the aforesaid drawbacks.

Another purpose of the invention is to propose a command input device for a game pad that is more ergonomic for inputting a command, when said game pad is held in the hand.

Yet another purpose of the invention is to propose a command input device for a game pad that makes it easier to input commands regardless of which finger is used, apart from the thumb.

### SUMMARY

The invention proposes to achieve at least one of the aforementioned purposes using a command input device for a game pad that is provided to be arranged on a rear face of said game pad, said device comprising at least one actuator, called paddle, comprising:
a part, called fixing part, provided to be fixed on said rear face, and
a part, called manipulation part, having a contact surface provided to be manipulated by at least one finger of a user apart from the thumb;
   characterized in that said paddle has a geometry such that, when it is fixed on said rear face:
said manipulation part is positioned between said fixing part and a lateral edge of said game pad, and
said paddle is curved between said fixing part and said manipulation part so that said paddle becomes further away from said rear face on the side of said manipulation part.

The device according to the invention makes it possible to input commands more ergonomically. As the manipulation part is curved and at an increased distance away from the rear face, it forms a non-zero angle with respect to the fixing part and/or the rear face of the game pad. As a result, unlike the devices of the state of the art, a command can be input by exerting pressure in a direction that is not perpendicular to the rear face of the game pad, which corresponds to the natural rotary or gripping movement of a finger of a hand holding the game pad on an edge, or a lateral face, of the game pad in the palm of the hand. Furthermore, as such a movement is more natural, inputting a command is quicker and requires less force on the part of the user with the device according to the invention.

The device according to the invention makes it possible to input commands more easily, and using approximately the same pressure, regardless of the finger used. As the manipulation part is situated between the fixing part and a lateral edge (or face) held by one hand, inputting a command is carried out by rotating/flexing the paddle about an axis joining an upper and a lower face of the game pad, i.e. an axis substantially parallel to the axis of grip of the game pad by the hand. Unlike the devices of the state of the art, the axis of rotation/flexing of the actuator is therefore at a distance from each finger of the user (apart from the thumb), thus allowing each finger to exert approximately the same pressure when inputting a command.

In the present application, the following terms are defined:
“front face”, the face of the game pad turned towards the user when the game pad is in use,
“rear face”, the face of the game pad turned away from the user when the game pad is in use,
“upper face” or “upper edge”, the face or edge of the game pad located between the front face and the rear face, and turned up when the game pad is in use,
“lower face” or “lower edge”, the face or edge of the game pad located between the front face and the rear face, and turned down when the game pad is in use,
“lateral face” or “lateral edge”, the face or edge of the game pad located between the front face and the rear face, and located on one side of the game pad when the game pad is in use, allowing the game pad to be held by gripping in the palm of the hand.

Advantageously, the device according to the invention can comprise a plurality of paddles, such as the one described above.

For example, the device according to the invention can comprise a paddle provided to be fixed on the side of each of the lateral edges of the game pad.

Alternatively or in addition, the device according to the invention can comprise for at least one, in particular each, edge of the game pad, several paddles provided to be fixed on the side of said edge of the game pad and manipulated by the fingers of the hand holding said edge of the game pad.

In this case, at least two paddles arranged on the side of one and the same edge can be superimposed in a direction perpendicular to the rear face. Alternatively or in addition, at least two paddles arranged on the side of one and the same edge can be superimposed in a direction parallel to the rear face and joining the upper or lower faces of the game pad. Alternatively or in addition, at least two paddles arranged on the side of one and the same edge can be superimposed in a direction parallel to the rear face and joining the lateral faces of the game pad held by the user.

Each of the paddles can be used to input one and the same command. Alternatively, at least two paddles can be used to input commands that are different from one another.

Advantageously, the device according to the invention can comprise at least two paddles that are mirror images of one another, i.e. enantiomorph of one another, allowing greater ease of accommodation and improved ergonomics for the user.

According to a particularly advantageous feature, the device according to the invention can comprise at least two, in particular exactly two, one-block paddles, in particular formed in a single piece, joining together at the fixing part.

Thus, the positioning of the paddles on a game pad is quicker and easier.

In addition, said at least two paddles can each comprise a narrowing, in order to provide each one with mobility/flexing ability with respect to the rear face, independently of one another. Alternatively, said at least two paddles can each comprise a rigid part, itself mobile with respect to the fixing part.

Advantageously, said device according to the invention can comprise a fixing means common to at least two paddles.

Thus, fixing the device according to the invention on a game pad is quicker, cheaper and less damaging for the game pad.

The fixing means can be provided to be positioned at a central area of the rear face of the game pad with respect to the lateral edges of the game pad, in particular substantially equidistant from each lateral edge/face of the game pad.

Alternatively or in addition, the fixing means can be provided to be positioned at a central area of the rear face of the game pad with respect to the upper and lower surfaces of the game pad, in particular substantially equidistant from the upper and lower surfaces of the game pad.

Each paddle can have the same dimensions, in particular the same width, so that, for example, for each paddle the fixing part is situated between the manipulation parts in a position determined so that, when it is fixed as determined onto the rear face of a game pad between two lateral edges or lateral faces of said game pad, each manipulation part is situated equidistant from one of said lateral edges or lateral faces.

At least one, in particular each, paddle can advantageously have a free end on the side of the manipulation part.

More particularly, the manipulation part can be formed, at least partially, by the free end of the paddle.

In particular, for at least one, preferably each, paddle, the free end moves away from the rear face of the game pad and is located outside the frame of the game pad.

Preferably at least one, in particular each, paddle can be curved so that the angle between the manipulation part and the fixing part varies in a direction joining an upper face and a lower face of the game pad. Such a direction is in particular a direction perpendicular to the upper face and/or the lower face, or a direction parallel to the direction of gripping the game pad, i.e. a direction about which the palm of the hand closes in order to hold the game pad.

Such a feature makes it possible to propose more satisfactory and easier access to the manipulation part for each of the fingers of the hand apart from the thumb, allowing easy command inputting regardless of which finger is used.

Preferentially, the angle between the manipulation part and the fixing part can increase along such a direction, in the direction running from the upper face to the lower face. Thus, the manipulation part has an increasing angle from the index finger to the little finger with respect to the fixing part (and the rear face of the game pad). In this way, in order to input a command, the pressure remains the same regardless of the finger used.

For at least one, in particular each paddle, the angle formed between the manipulation part and the fixing part, and in particular the rear face of the game pad, can be comprised between 10° and 90°, and preferentially between 35° and 55°, even more preferentially between 40° and 50°. This makes it possible to input a command in a direction that is inclined with respect to the rear face of the game pad, which is naturally more satisfactory for the fingers of a hand holding the game pad by a lateral edge thereof.

According to an advantageous feature, the manipulation part of at least one, in particular each, paddle can have a variable width, in particular increasing, along a direction joining an upper face and a lower face of the game pad, in particular an increasing width in the direction running from the upper face to the lower face. Such a direction can be in particular a direction perpendicular to the upper face of the game pad and/or the lower face of the game pad, or a direction parallel to the direction of gripping the game pad, i.e. a direction about which the palm of the hand closes in order to hold the game pad.

In this way, the manipulation part can be easily accessed by each of the fingers of the user (apart from the thumb). Generally the shortest fingers of the hand are the ring finger and especially the little finger. The fact that the width of the manipulation part is variable and in particular increasing from the index to the little finger allows easy access to all the fingers of the hand (apart from the thumb).

Moreover, the manipulation part of at least one, in particular each, paddle can have a height determined so that it is greater than or equal to half the height of the rear face of a game pad on which it is intended to fix said device, defined in a direction joining an upper face and a lower face of the game pad that are separated by said rear face. Such a direction can be in particular a direction perpendicular to the upper face of the game pad and/or the lower face of the game pad, or a direction parallel to a direction of gripping the game pad, i.e. a direction about which the palm of the hand closes in order to hold the game pad.

In this way, the paddle remains accessible to each finger of the hand apart from the thumb, regardless of the size of the user's hand or its position on a lateral edge of the game pad.

The height of the fixing part of at least one, in particular each, paddle can increase in the direction in which said paddle extends.

Thus, said paddle has a satisfactory strength, in particular on the side of the manipulation part subject to pressure by the user, while optimizing the quantity of material used for its manufacture.

According to a particularly preferred embodiment, at least one paddle can have the general shape of a butterfly wing with the fixing part located on the side of the base of said butterfly wing and the manipulation part on the side of the free end of said butterfly wing, said butterfly wing being folded between said fixing part and said manipulation part.

According to a particular embodiment, at least one, in particular each, paddle can be presented in the form of a plate, of insignificant thickness, the fixing and manipulation parts being located on the side of two opposite ends of said plate, said plate being curved between said ends about a direction:
parallel to the plane formed by said plate, and
perpendicular to a direction joining said opposite ends.

The fixing means of at least one, in particular each, paddle can be a fixing surface provided to be bonded to a rear face or any other means of fixing by bonding, clipping, etc.

Preferentially, the fixing means of at least one, in particular each, paddle can be a through hole provided to receive a screw to be accommodated on the rear face of the game pad.

At least one, in particular each, paddle can be provided to actuate at least one binary or progressive sensor arranged on/in the rear face of the paddle when said paddle is rotated/flexed.

Alternatively or in addition, each paddle can comprise on/in a face of said paddle, opposite the rear face of the game pad, one or more sensors provided to be put in contact with the rear face of said game pad when said paddle is rotated/flexed.

According to another aspect of the invention, a command input game pad for an electronic or computer device is proposed, in particular a device executing a video game, comprising at least one command input device according to the invention arranged on its rear face.

For example, the command input device can be fixed at mid-height or in a lower half of the rear face of said game pad.

In addition, the command input device can be fixed equidistant from each of the lateral edges of the game pad.

According to an embodiment that is in no way limitative, the game pad according to the invention can be equipped with a command input device according to the invention comprising two paddles, mirror images of one another, each having a butterfly wing shape, produced in a single piece and having a common fixing means, each paddle:
being fixed to the rear face of said game pad at a central area of said rear face, and
extending to a lateral edge of said game pad so as to present a free end on the side of said lateral edge;
   so that each paddle is rotated or flexed about an axis joining the upper and lower faces of said game pad.

### BRIEF DESCRIPTION OF THE DRAWINGS

Other advantages and features will become apparent on examination of the detailed description of embodiments that are no way limitative and of the attached drawings in which:

FIG. 1 is a diagrammatic representation of an example of a game pad according to the prior art;

FIGS. 2a and 2b are diagrammatic representations of a first example of a command input device according to the invention; and

FIGS. 3a to 3c are diagrammatic representations of a second example of a command input device according to the invention.

### DETAILED DESCRIPTION

It is well understood that the embodiments that will be described hereinafter are in no way limitative. Variants of the invention can in particular be envisaged comprising only a selection of the features described below in isolation from the other described features, if this selection of features is sufficient to confer a technical advantage or to differentiate the invention with respect to the state of the prior art. This selection comprises at least one preferably functional feature without structural details, or with only a part of the structural details if this part is the one uniquely sufficient to confer a technical advantage or to differentiate the invention with respect to the state of the prior art.

In particular, all the described variants and embodiments may be combined if there is no objection to this combination from a technical point of view.

In the figures and in the remainder of the description, the elements common to several figures retain the same references.

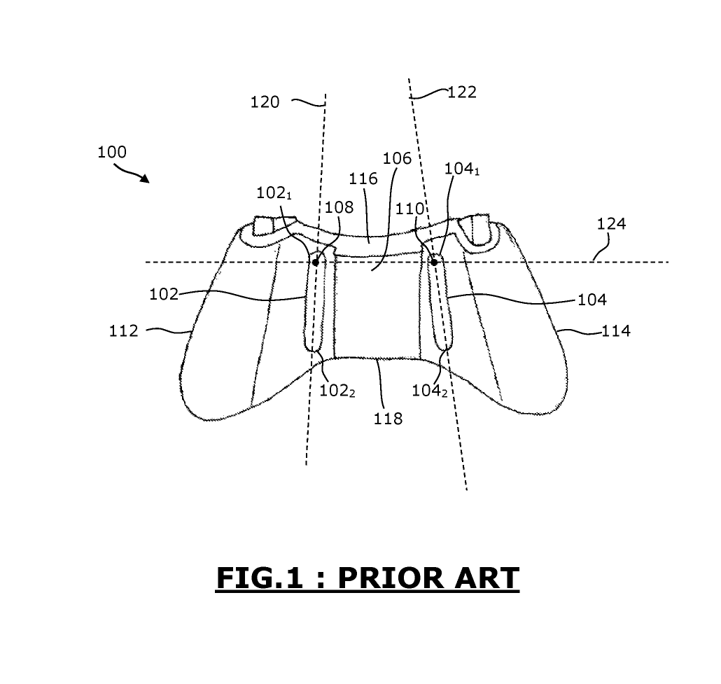

FIG. 1 is a diagrammatic representation of an example of a game pad according to the prior art comprising two command paddles.

The game pad 100 shown in FIG. 1 comprises two control paddles 102 and 104 fixed on a rear face 106 of the game pad using a fixing screw, respectively 108 and 110, on the side of a lateral face, respectively 112 and 114, of the game pad 100.

Each paddle 102, 104 is in the form of an elongated flexible plastic plate of insignificant thickness. Each paddle 102, 104 which is fixed by one of its ends, respectively 1021 and 1041, on the rear face 106 of the game pad 100 on the side of an upper face 116 of the game pad 100 and extends in a straight line to the lower face 118 of the game pad 100 so that it has a free end, respectively 1022 and 1042, on the side of said lower face 118.

Each paddle 102, 104 thus extends in a direction represented respectively by the straight line referenced 120 and the straight line referenced 122 in FIG. 1, joining the upper face 116 and the lower face 118. In addition each paddle 102 and 104 is arranged on the game pad 100 so that the contact surface of each paddle 102, 104 is substantially parallel to the rear face 106 of the game pad 100.

In the example shown in FIG. 1, the user can enter a command by exerting pressure on each paddle 102, 104 with the fingers of one hand apart from the thumb. When the user presses on a paddle 102, 104, the latter is made to rotate or flex about an axis represented by the straight line 124.

Each of these paddles has several major drawbacks. Firstly, it is not possible to input a command with a finger located on (or close to) the fixing end, respectively 1021 and 1041, of the paddle. In other words, it is not possible to input a command over the paddle along its entire length. Secondly, the force to be used in order to flex the paddle varies along the paddle. It increases when approaching the fixing end 1021 and 1041 and reduces when approaching the free end 1022 and 1042. Finally, as the contact surface of each paddle 102, 104 is parallel to the rear face 106 of the game pad 100, in order to enter a command, pressure must be exerted in a direction perpendicular to the rear face of the game pad, which is neither natural nor ergonomic when the game pad is held by a hand at each of the edges 112 and 114 thereof.

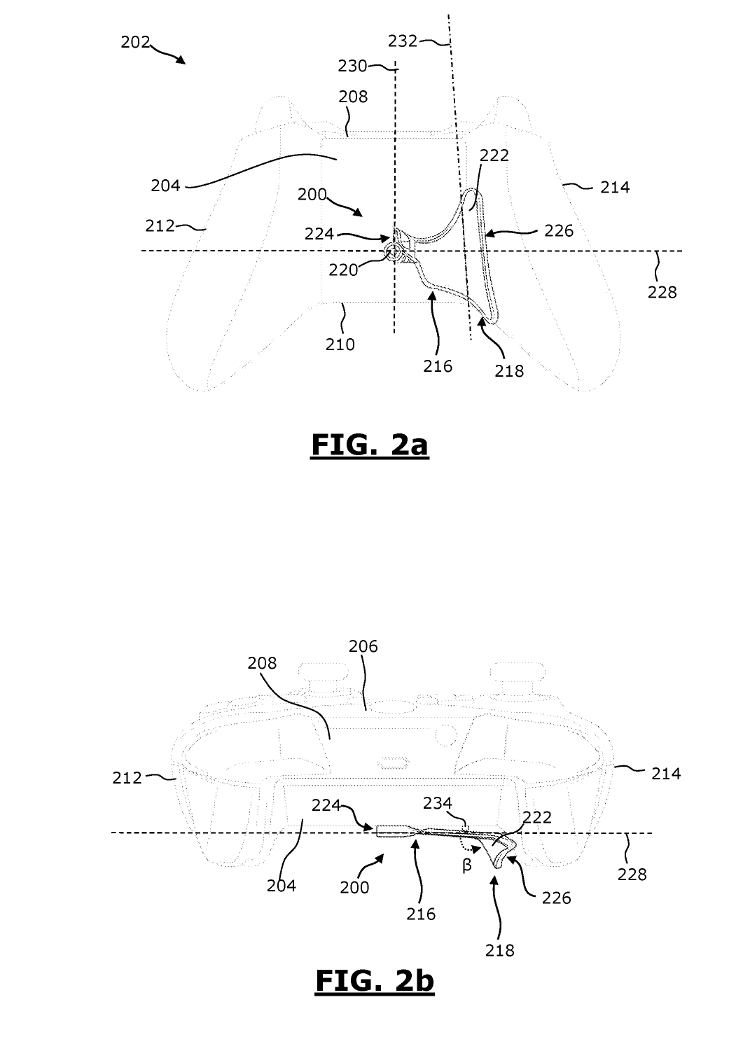

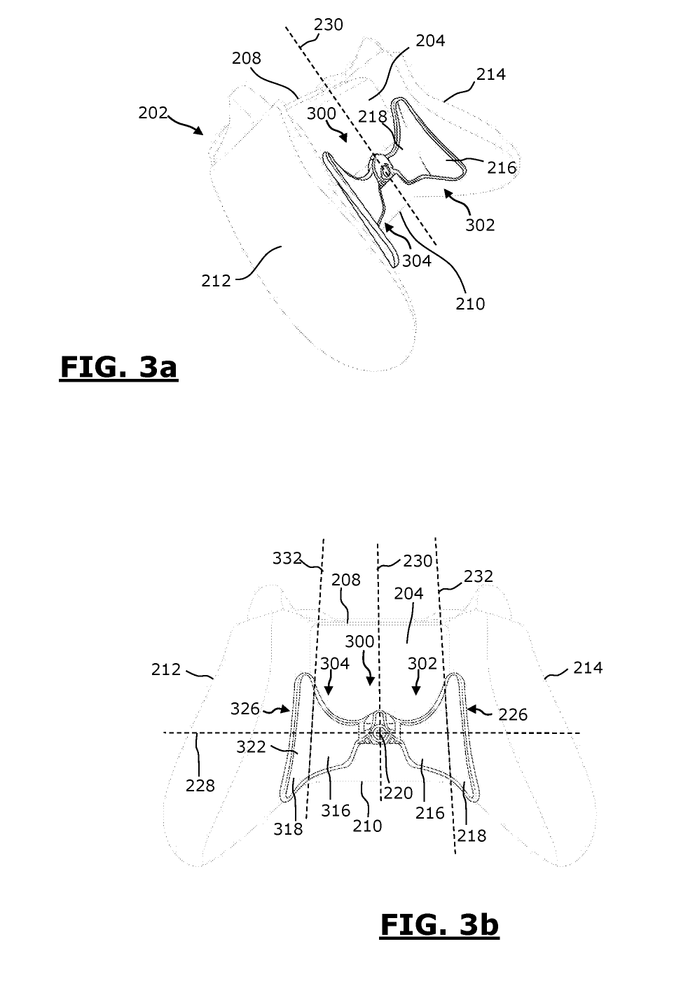

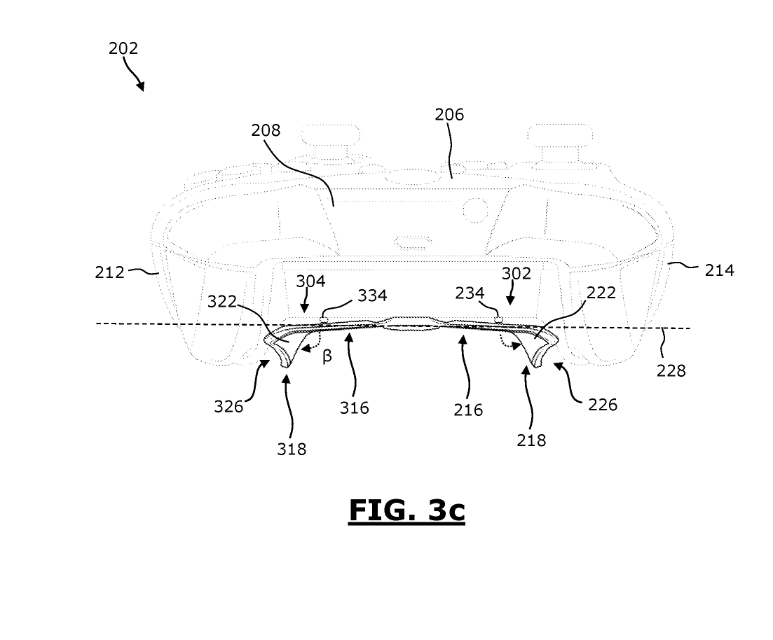

In order to overcome these drawbacks, the present invention proposes a command input device for a game pad, two non-limitative examples of which will be described hereinafter with reference to FIGS. 2a-2b and FIGS. 3a and 3b.

FIGS. 2a and 2b are diagrammatic representations of a first embodiment of a command input device according to the invention.

The command input device 200 is shown in FIGS. 2a and 2b together with a game pad 202, and in particular fixed on the rear face 204 of the game pad 200 which also comprises
a front face 206 turned towards the user when the game pad is in use and opposite the rear face 204,
an upper face or “upper edge”, 208 located between the front face and the rear face, and turned up when the game pad is in use,
a lower face or “lower edge” 210 located between the front face and the rear face, and turned down when the game pad is in use,
two lateral faces or two lateral edges, respectively 212 and 214, located between the front face and the rear face, each on a side of the game pad when the game pad is in use, and allowing the game pad to be held gripped in the palm of the user's hand.

The device 200 is shown in FIG. 2a with a view of the rear face 204 of the game pad and in FIG. 2b with a view of the upper face 208 of the game pad.

The device 200 shown in FIGS. 2a and 2b consists of a paddle provided for manipulation by the fingers of a hand located on the side of the lateral edge 214 of the game pad 202 and holding the game pad by said lateral edge 214.

The device 200 comprises a fixing part 216 and a manipulation part 218. The fixing part 216 comprises a fixing hole 220 through which passes a screw (not shown) for fixing the paddle 200 on the rear face 204 of the game pad 202. The manipulation part 218 comprises a surface 222, called contact surface, provided to receive the pressure of a user's finger.

The fixing part 216 is located on the side of one end 224 of the paddle 200 comprising the fixing hole 220 and the manipulation part 218 is located at a free end 226 of the paddle located on the side of the lateral edge 214 of the game pad.

The paddle 200 is fixed on the rear face 204 of the game pad 202 so that the manipulation part is located between the fixing part 216 and the lateral edge 214 of the game pad 202. More particularly, the paddle 200 extends in a direction, represented by the straight line referenced 228, joining the lateral edges 212 and 214 of the game pad.

According to the invention and independently of the examples given, this direction 228 can be parallel to the upper face 208 of the game pad or can have an angle less than or equal to 45° with respect to said upper face 208.

The paddle 200 is made to rotate or flex about an axis, represented by the straight line 230, joining the upper face 208 and lower face 210 of the game pad. This direction 230 is in particular perpendicular to the upper face 208, and/or to the lower face 210 of the game pad 202.

According to the invention, and independently of the examples given, this direction 230 can be in particular substantially parallel, give or take a few degrees, to the direction of grip of the game pad by the edge 214 or can have a smaller angle greater than or equal to 45° with respect to the upper face 208.

In addition, the paddle 200 is curved in a direction, represented by the straight line 232, joining the upper 208 and lower 210 faces of the game pad, so that the manipulation part 218, and in particular the contact surface 222, forms a non-zero angle β with respect to the fixing part 216, and in particular with respect to the rear face 204 of the game pad 202, and becomes increasingly further from the rear face 204 of the game pad 202. This angle β is preferentially comprised between 35 and 55°. In the example shown in the FIGURES the angle β varies, increasing along the direction 232 towards the lower face 210 of the game pad 202.

According to the invention, and independently of the examples given, the direction 232 can in particular be substantially parallel, give or take a few degrees, to the direction of grip of the game pad by the edge 214 or can have a smaller angle greater than or equal to 45° with respect to the upper face 208.

In the example shown, the paddle 200 is produced in one piece made from resilient flexible plastic, substantially flat so that its thickness is insignificant and folded along the axis 232.

The height of the paddle 200, measured in the direction 230, increases along the direction 228 in which the paddle extends, so that the height of the paddle on the side of its free end 226 is greater compared with its height on the side of its fixed end 224.

The width of the manipulation part 218, and in particular of the contact surface 222, measured in the direction 228 in which the paddle extends, increases towards the lower face 210 of the game pad 202 along the direction 230 about which the paddle 200 is flexed (and/or along the direction 230 in which the paddle is curved or folded) so that the manipulation part 218, and in particular the contact surface 222, has a width on the side of the lower face 210 of the game pad 202 that is greater than its width on the side of the upper surface 208 of the game pad 202.

The paddle 200 shown in FIGS. 2a and 2b has the general shape of a butterfly wing, curved or folded, with the fixing part 216 on the side of the base of said wing and the manipulation part on the opposite side.

The paddle 200 is associated with a sensor 234, arranged in the rear face 204 of the game pad 202 under the paddle 200 and in particular under the fixing part 216 of the game pad. When the user exerts pressure on the manipulation part 218, in particular on the contact surface 222 of the paddle 200, the latter is flexed and comes into contact under pressure with the sensor 234 so that the pressure exerted by the user is detected. When the user stops pressing on the paddle, the latter returns flexibly to its idle position and is no longer in contact with the sensor 234.

In the non-limitative example shown in FIGS. 2a and 2b, the device 200 comprises a single paddle only. Of course, the device according to the invention can comprise several paddles, having identical or different forms and/or identical or different dimensions. The device can comprise one or more paddles arranged on the side of one and the same lateral edge of the game pad or distributed over the two lateral sides of the game pad and superimposed in the plane of the rear face of the game pad or in a direction vertical to said rear face.

FIGS. 3a and 3c are diagrammatic representations of a preferred, but in no way limitative, embodiment of the device according to the invention comprising two control paddles.

The device 300 is shown in FIGS. 3a-3c with the game pad 202 of FIGS. 2a and 2b. The device 300 is shown in FIG. 3a with a view at an angle of the lateral edge 212 of the game pad, in FIG. 3b with a view of the rear face 204 of the game pad and in FIG. 3c with a view of the upper face 208 of the game pad.

The device 300 comprises two paddles 302 and 304, each on the side of a lateral face, respectively 214 and 212, of the game pad 202.

The paddle 302 is identical to the paddle 200 of FIGS. 2a and 2b described above.

The paddle 304 has a shape, dimensions and positioning such that it is a mirror image of the paddle 302, and thus the paddle 200, with respect to the axis 230. In other words, everything described for the paddle 200 shown in FIGS. 2a and 2b can be applied to the paddle 304 by applying symmetry with respect to axis 230.

In brief, the paddle 304 extends to the lateral edge 212 in the direction 228. It comprises a manipulation part 318, provided with a contact surface 322, and a fixing part 316, between them curved around the direction 332 so that the manipulation part 318 forms a non-zero angle β with respect to the fixing part 316, and in particular with respect to the rear face 204 of the game pad 202. The manipulation part 318 is located between the fixing part 316 and the lateral edge 212 of the game pad 202. It can be flexed with respect to the axis 230 described above. It is associated with a sensor 334, similar or identical to the sensor 234 associated with the paddle 200 described above, positioned under the paddle 304 in or on the rear face 204 of the game pad 202. It comprises a free end 326 on the side of the lateral edge 212 of the game pad 202.

The paddles 302 and 304 comprise a common fixing means, namely the fixing hole 220, with respect to which each of the paddles is flexible independently of the other.

This fixing hole is positioned equidistant from each of the lateral edges 212 and 214 of the game pad 202 and in the lower half of the rear face 204, i.e. in the half of the rear face 204 on the side of the inner face 210 of the game pad 202.

The device 300 is produced in a single piece by moulding or by folding a plastic piece that initially is substantially planar. It has an insignificant thickness with respect to its maximum height and its width.

Of course, the invention is not limited to the examples that have just been described.

1. A command input device for a game pad provided to be arranged on a rear face of said game pad, said device comprising at least one actuator, called a paddle, comprising:
a part, called fixing part, provided to be fixed on said rear face, and
a part, called manipulation part, having a contact surface provided to be manipulated by at least one finger of a user apart from the thumb;
said paddle has a geometry such that, when it is fixed on said rear face;
said manipulation part is positioned between said fixing part and a lateral edge of said game pad, and
said paddle is curved between said fixing part and said manipulation part so that said paddle becomes further away from said rear face on the side of said manipulation part.

2. The device according to claim 1, characterized in that it comprises at least two paddles that are enantiomorph of each other.

3. The device according to claim 1, characterized in that it comprises at least two, in particular exactly two, one-block paddles, in particular formed in a single piece, joining together at the fixing part.

4. The device according to claim 3, characterized in that it comprises a fixing means common to at least two paddles.

5. The device according to claim 1, characterized in that at least one, in particular each, paddle has a free end on the side of the manipulation part.

6. The device according to claim 1, characterized in that at least one, in particular each, paddle is curved so that the angle (β) between the manipulation part and the fixing part varies along a direction joining an upper face and a lower face of the game pad.

7. The device according to claim 1, characterized in that an angle (β) formed between the manipulation part and the fixing part is comprised between 10° and 90°, and preferentially between 35° and 55°.

8. The device according to claim 1, characterized in that the manipulation part of at least one, in particular each, paddle has a width that increases along a direction joining an upper face and a lower face of the game pad.

9. The device according to claim 1, characterized in that the manipulation part of at least one, in particular each, paddle has a height determined so that it is greater than or equal to half the height of the rear face of a game pad on which it is intended to fix said device, defined in a direction joining an upper face and a lower face of the game pad that are separated by said rear face.

10. The device according to claim 1, characterized in that the fixing part of at least one, in particular each, paddle has a height that increases in the direction in which said paddle extends.

11. The device according to claim 1, characterized in that at least one paddle has the general shape of a butterfly wing with the fixing part located on the side of the base of said butterfly wing and the manipulation part on the side of the free end of said wing, said wing being folded between the fixing part and the manipulation part.

12. The device according to claim 1, characterized in that at least one, in particular each, paddle is presented in the form of a plate, of insignificant thickness, the fixing and manipulation parts being located on the side of two opposite ends of said plate, said plate being curved between said ends about a direction:
parallel to the plane formed by said plate, and
perpendicular to a direction joining said opposite ends.

13. A command input game pad for an electronic or computer device, in particular a device executing a video game, comprising at least one command input device according to claim 1 arranged on its rear face.

14. The game pad according to claim 13, characterized in that the command input device is fixed at mid-height or in a lower half of the rear face of said game pad.

15. The game pad according to claim 14, characterized in that the command input device comprises two paddles, mirror images of one another, each having a butterfly wing shape, produced in a single piece and having a common fixing means, each paddle:
being fixed to the rear face of said game pad at a central area of said rear face, and
extending to a lateral edge of said game pad so as to present a free end on the side of said lateral edge;
so that each paddle is rotated or flexed about an axis joining the upper and lower faces of said game pad.
